(19) United States
(12) Patent Application Publication
(10) Pub. No.: US 2007/0133593 A1
(43) Pub. Date: Jun. 14, 2007

(54) Searching Strings Representing a Regular Expression

(76) Inventor: Udaya Shankara, Bangalooru (IN)

Correspondence Address: Jerray Wei;c/o BLAKELY, SOKOLOFF, TAYLOR & ZAFMAN LLP, Seventh Floor, 12400 Wilshire Boulevard, Los Angeles, CA, 90025, US

(21) Appl. No.: 11/673,420

(22) Filed: Feb. 9, 2007

(30) Foreign Application Priority Data
Nov. 21, 2005 (IN) 2749/DEL/2005

(51) Int. Cl. H04L 12/66; H04L 12/56

(52) U.S. Cl. 370/463; 370/395.32

(57) ABSTRACT

A network device may determine the presence of one or more strings corresponding to a regular expression. The network device may comprise a CAM that may generate entries corresponding to the regular expression based on a tree structure representing the regular expression. The CAM may optimize the size of the memory and the computational resources based on assigning states that differ by one bit to each node of the tree and by using a content matchable memory (CMM) to detect the presence of several occurrences of a substring in a reduced number of comparisons.

This application claims priority to Indian Patent Application 2749/DEL/2005 filed on Oct. 13, 2005.

### BACKGROUND

A computer network generally refers to a group of interconnected wired and/or wireless medium devices such as laptops, desktops, mobile phones, servers, fax machines, printers that may share resources. One or more intermediate devices such as switches and routers may be provisioned between end devices to support data transfer. Each intermediate device after receiving a message may, for example, search the message for the presence of one or more specific strings.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates an embodiment of a network environment.

FIG. 2 illustrates an embodiment of a network device of the network environment of FIG. 1.

FIG. 3 illustrates an embodiment of an operation of the network device to detect a string representing a regular expression.

FIG. 4 illustrates a tree and a corresponding transition diagram corresponding to the regular expression.

FIG. 5 illustrates an embodiment of the CAM detecting the presence of the regular expression.

FIG. 6 illustrates an embodiment of the CAM performing comparisons to detect the presence of the string.

FIG. 7 illustrates an embodiment of the CAM operating using reduced number of entries to detect the presence of the regular expression.

FIG. 8 illustrates an embodiment of the CAM comprising a priority encoder to reduce the number of comparisons while detecting the presence of the regular expression.

FIG. 9 illustrates an embodiment of the CAM comprising a content matchable memory to detect the presence of the regular expression.

### DETAILED DESCRIPTION

The following description describes a Content Addressable Memory (CAM) used for searching strings representing a regular expression. In the following description, numerous specific details such as logic implementations, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits, and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

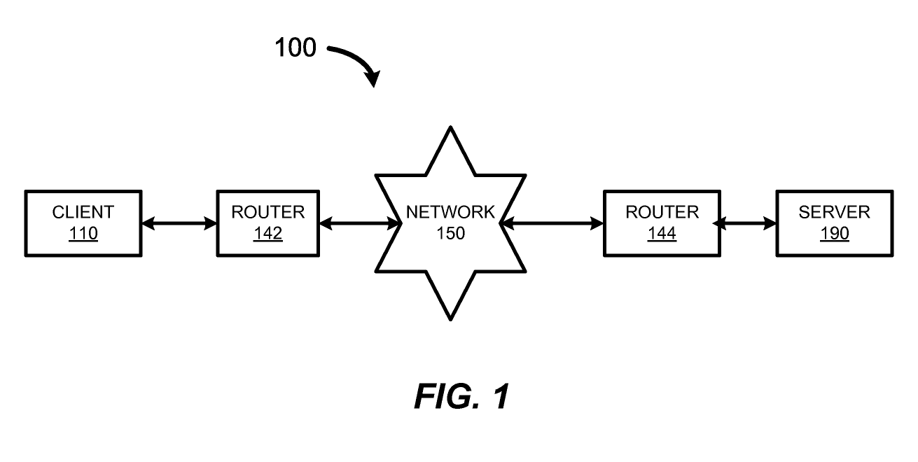

An embodiment of a network environment 100 is illustrated in FIG. 1. The network environment 100 may comprise network devices such as a client 110, routers 142 and 144, a network 150, and a server 190. For illustration, the network environment 100 is shown comprising a small number of each type of network devices. However, a typical network environment may comprise a large number of each type of such network devices.

The client 110 may comprise a computer system such as a desktop or a laptop computer that comprises various hardware, software, and firmware components to generate and send data packets to a destination system such as the server 190. The client 110 may be coupled to an intermediate device such as the router 142 via a local area network (LAN) or any other wired or wireless medium to transfer packets or data units. The client 110 may, for example, support protocols such as hyper text transfer protocol (HTTP), file transfer protocols (FTP), TCP/IP and such other protocols.

The server 190 may comprise a computer system capable of generating response corresponding to a request received from another network device such as the client 110 and transfer the responses to the network 150. The server 190 may be coupled to the router 144 via another LAN or any wired or wireless network. The server 190 may comprise a web server, a transaction server, a database server, or any such systems.

The network 150 may comprise one or more intermediate devices such as switches and routers, which may receive, process, and send the packets to an appropriate intermediate device or an end device. The network 150 may enable end systems such as the client 110 and the server 190 to transmit and receive data. The intermediate devices of the network 150 may be configured to support various protocols such as TCP/IP.

The routers 142 and 144 may enable transfer of messages between the network devices such as the client 110 and the server 190 and the network 150.

In one embodiment, the router 142 may comprise Intel® IXP 2400® network processor for performing packet processing. For example, the router 142 after receiving a packet from the client 110 may determine a next router provisioned in the path to the destination system and forward the packet to the next router.

Also, the router 142 may forward a packet, received from the network 150, to the client 110. The router 142 may determine the next router based on one or more routing table entries, which may comprise an address prefix and one or more port identifiers.

The routers 142 and 144 may support text editing, security, billing, differentiated service levels, and such other features as well. In one embodiment, the routers 142 and 144 may perform operations such as searching the messages to detect the presence of one or more pre-defined strings representing, for example, a regular expression. In one embodiment, the regular expression may represent an expression that represents a set of strings. The routers 142 and 144 may determine that the regular expression is detected in the message if any of the string in the set of strings is present in the message.

Applications supported by the router 142 may peek into the message, such as for load balancing purposes. The routers 142,144, or any other network device may utilize substantial computational resources to determine the output port or to perform string search operations.

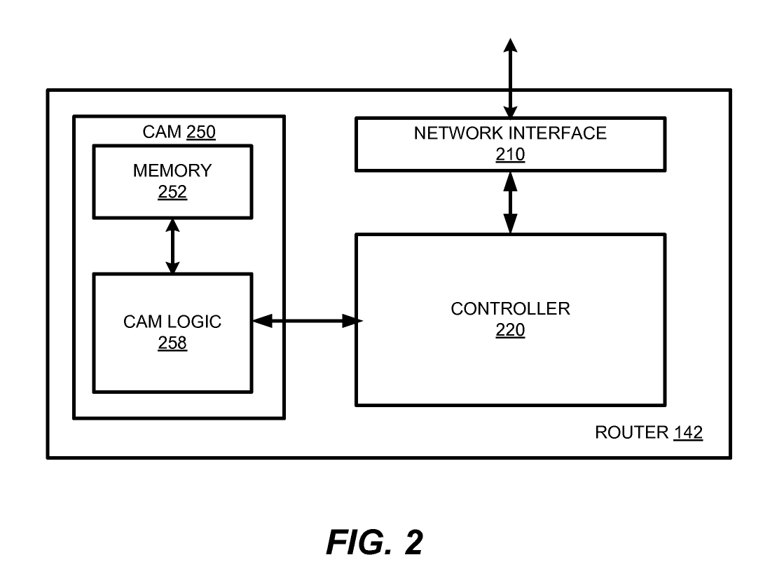

An embodiment of the router 142 is illustrated in FIG. 2. The router 142 may comprise a network interface 210, a controller 220, and a Content Addressable Memory (CAM) 250. Other devices of the network environment 100 such as the router 144, client 110 may also be implemented in a similar manner.

The network interface 210 may provide an interface for the router 142 to send and receive messages to and from one or more network devices coupled to the router 142. For example, the network interface 210 may receive one or more packets from the client 110, send the corresponding packets to the controller 220 for further processing, receive control data and the processed packets from the controller 220, and forward the packets to the network 150. The network interface 210 may provide physical, electrical, and protocol interfaces to transfer messages between the client 110 and the network 150.

In one embodiment, the controller 220 may receive messages from the network interface 210, process the message, and then provide the control data to the network interface 210. In one embodiment, the controller 220 may cooperatively operate with the CAM 250 to process the message. In one embodiment, the controller 220 may receive a packet, extract packet parameters such as the source address, destination address, protocol identifier, and provide the packet parameters to the CAM 250. In response, the controller 220 may receive, for example, an output port identifier on which the packet may be sent onward. The controller 220 after receiving the response may further process the packet and may perform various functions such as forwarding the packet to the network interface 210 based on the output port identifier or dropping the packet.

In another embodiment, the controller 220 may receive a regular expression; one or more messages such as packets, extract data bytes such as payloads, and provide the regular expression and the data bytes to the CAM 250. In response, the controller 220 may receive a signal indicating the presence or absence of one or more strings in the message that represent the regular expression. In one embodiment, the controller 220 may receive the regular expression and pass on the regular expression to the CAM 250 and in some other embodiments the controller 220 generate entries based on the regular expression and may send the entries to the CAM 250.

In one embodiment, the CAM 250 may be implemented as a hardware component to quickly process the received messages. For example, the CAM 250 may generate an output port identifier and/or detect presence of one or more strings, in the message, corresponding to the regular expression. In one embodiment, the CAM 250 may generate a key comprising a destination address of a packet or the payload of the packet and compare the key with the entries to determine the presence of a match. In one embodiment, the CAM 250 may comprise a memory 252 and a CAM logic 258.

The memory 252 may comprise one or more memory locations to store the entries. In one embodiment, the memory 252 may comprise ternary storage elements each capable of storing a zero, one, or don't care bit (0,1,*). In other embodiments, the memory 252 may comprise pairs of binary storage elements to implement the don't care state.

The CAM logic 258 may update the address prefixes and corresponding port identifiers, stored in the memory 252, based on the routing information. The CAM logic 258 may update the entries, in the memory 252, to detect the strings that may correspond to the regular expression. The CAM logic 258 may generate entries based on a tree structure comprising one or more nodes and each node of the tree may represent a portion of the regular expression.

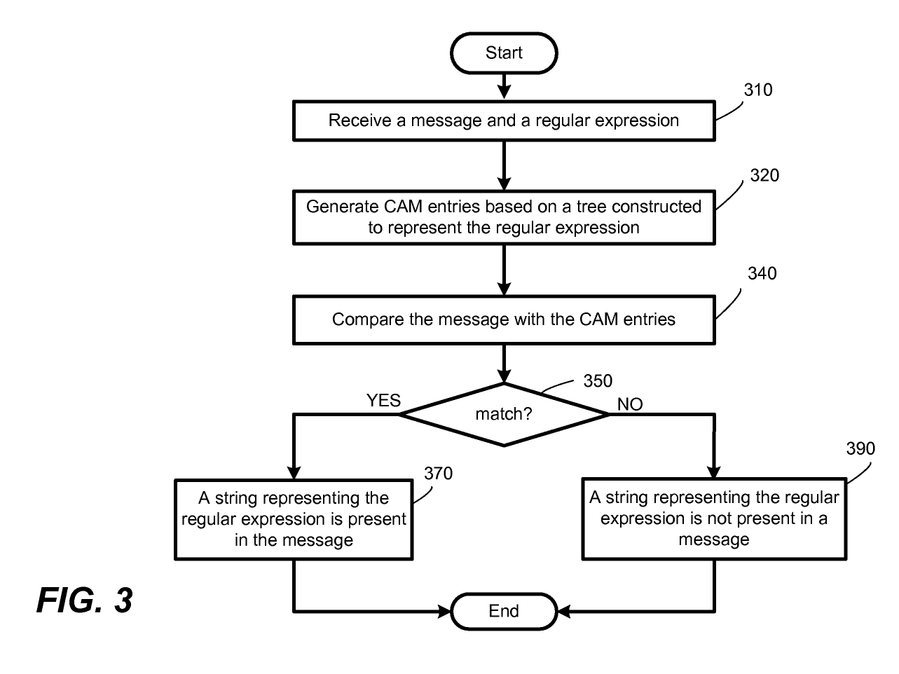

An embodiment of an operation of the router 142 comprising a CAM 250 is described in FIG. 3. In block 310, the CAM 250 may receive a message and a regular expression. The CAM 250 may operate to determine if a string corresponding to the regular expression is present in the message.

In block 320, the CAM 250 may generate entries based on a tree constructed to represent the regular expression. In one embodiment, the CAM 250 may construct the tree comprising one or more nodes with each node representing a portion of the regular expression.

In block 340, the CAM 250 may compare the message with the entries. In block 350, the CAM 250 may determine if one or more strings matching the regular expression is present in the message. Control passes to block 370 if a match is found and to block 390 otherwise.

In block 370, the CAM 250 may send a signal indicating that the message may comprise a string that corresponds to the regular expression. In block 390, the CAM 250 may send a signal indicating that the message does not comprise strings that correspond to the regular expression.

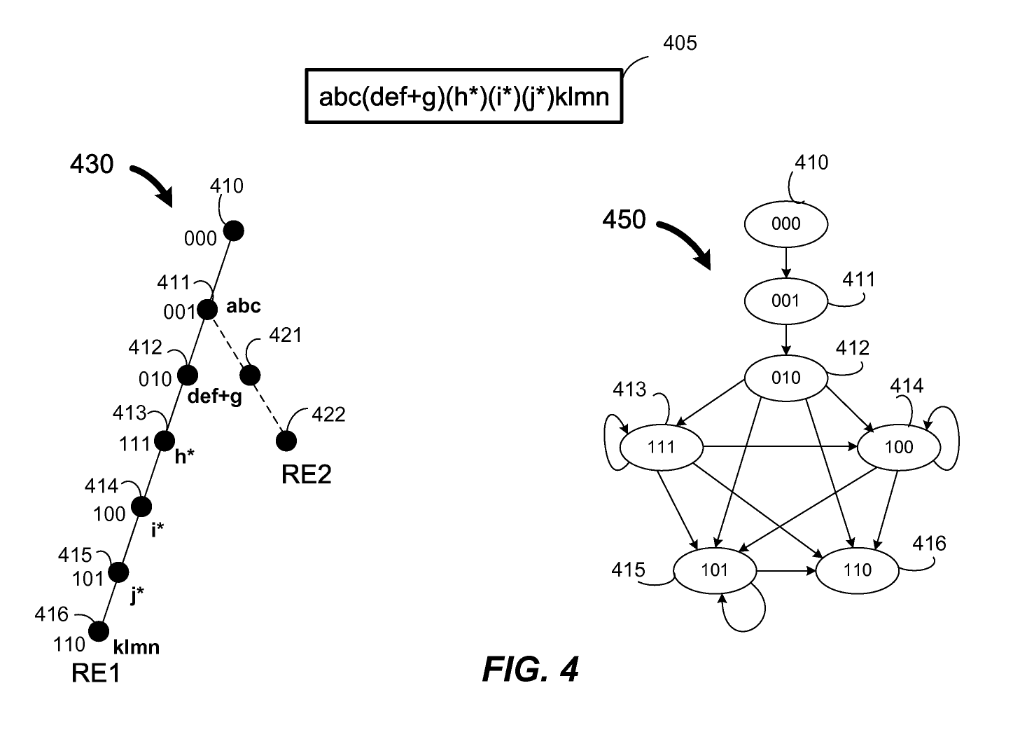

FIG. 4 illustrates a tree 430 and a corresponding transition diagram 450 corresponding to a first regular expression 405. The first regular expression (RE1) 405, for example, may equal abc(def+g)(h*)(i*)(j*)klmn, wherein the ‘+’ symbol indicates that the string may comprise a substring ‘abc’ followed by a substring ‘def’ or ‘g’ and ‘*’ indicates that the substrings ‘h’, ‘i’, or ‘j’, associated with the ‘*’, may occur zero or more times in the string and then followed by a substring ‘klmn’.

The tree 430 depicts the association between the substrings corresponding to the regular expression 405. The CAM logic 258 may associate each node of the tree 430 with a substring of the regular expression 405. In one embodiment, the tree 430 may comprise nodes 410-416 and 421-422 and the nodes 411-416 may be associated with the substrings (abc), (def+g), (h*), (i*), (j*), and (klmn) respectively. In the tree 430, a node 410 may be referred to as the root of the tree 430 and the node 410 may be assigned a state such as 000. The nodes 411-416 may be assigned states 001, 010,111,100,101, and 110 respectively, wherein a pair of states assigned to a pair of adjacent nodes may differ by more than one bit.

In one embodiment, the tree 430 may comprise one or more branches to represent one or more regular expressions. In one embodiment, the tree 430 may represent the RE1 405 and a second regular expression (RE2). The second regular expression RE2 may equal abc(j*)(klmp). In one embodiment, the RE1 and RE2 may comprise a common substring ‘abc’ and each branch of the tree 430 may comprise several nodes including the common substring. The nodes 421 and 422 of the second branch of the tree 430 may represent substrings (j*) and (klmp) respectively.

The transition diagram 450 depicts the possible transitions between the nodes of the tree 430. The node 411, representing ‘abc’, may be reached from an initial state 000 corresponding to the node 410. The node 412 representing (def+g) may be reached from an initial state 001 corresponding to the node 411. The node 412 may not be reached from the node 410 directly as the string representing the regular expression 405 starts with ‘abc’. The node 413 may be reached from an initial state 010 of the node 412.

Further, the node 414 may be reached from any of the three initial states 010,111, and 100, respectively, corresponding to the nodes 412, 413, and 414. For example, if the message comprises a string equaling ‘abcghi’, the path to the node 414 may comprise the nodes 411,412, 413, and 414. However, if the message comprises a string equaling ‘abcgi’, the path to the node 414 may comprise the nodes 411, 412, and 414 as the substring ‘h’ corresponding to the node 413 is absent in the string ‘abcgi’. If the message comprises ‘abcgii’, the path to the node 414 may comprise 411, 412, 414, and 414. Similarly the paths to reach nodes 415 and 416 from different initial states 010,111,100, and 101 corresponding to the nodes 412, 413, 414, and 415, respectively, is depicted in the transition diagram 450.

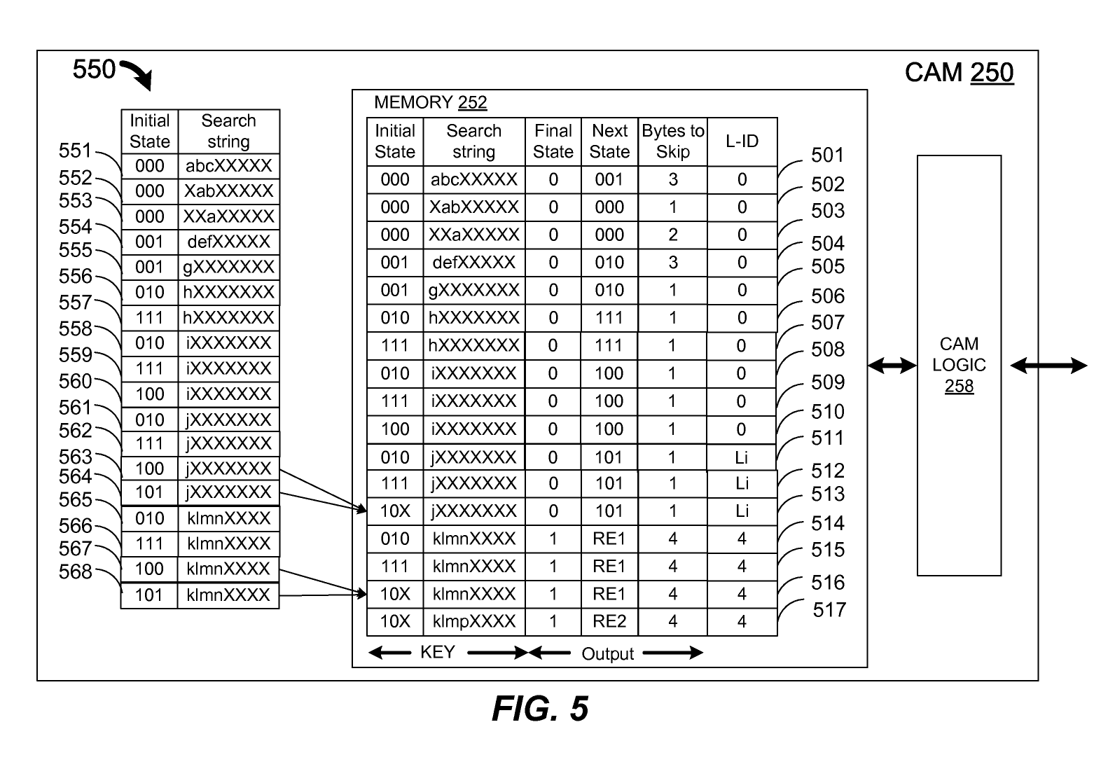

An embodiment of the CAM 250 is depicted in FIG. 5. The CAM 250 comprises the memory 252 for storing one or more entries generated by the CAM logic 258. For the RE1 405, the CAM logic 258 may generate 18 entries 551-568 shown in table 550 and the entries 551-568 may be generated based on the tree 430. However, some entries comprising initial states differing by one bit may be merged into a single entry by introducing ‘don't care bits’. Such an approach may reduce the number of entries and thus the size of the memory 252.

In one embodiment, the entries 563 and 564 and the entries 567 and 568 comprise initial states differing by one bit and the CAM logic 258 may merge the entries 563 and 564 into one single entry 513 and the entries 567 and 568 into one single entry 516. The entries 513 and 516 may respectively comprise ‘10X’ as the initial states, wherein X is a ‘don't care’. As a result, the entries stored in the memory 252 may reduce form 18 to 16. Thus, the memory 252 is shown comprising 16 entries 501-516.

The CAM logic 258 may compare each substring of the message with one or more of the entries 501-516 to determine if a string corresponding to the regular expression 405 is present in the message. Each entry 501-516 may comprise a key portion comprising two fields ‘initial state (IS)’ and ‘search string (SS)’ and an output portion comprising three fields ‘final state (FS)’, ‘next state (NS)’, and ‘bytes to skip (BS)’. For example, the entry 501 comprises ‘000’ and ‘abcXXXXX’ respectively in the IS and the SS fields and ‘0’, ‘001’, and 3, respectively, in the FS, the NS, and the BS fields. The CAM logic 258 may use the field values in the entries to detect if a string corresponding to the regular expression 405 is present.

In one embodiment, the CAM logic 258 may use the search string field of the key portion of the entry 501 to compare the first substring of the message. In one embodiment, the CAM logic 258 may determine the size of the substring (‘stride’) chosen for comparison based on the desired speed of operation. For example, the CAM logic 258 may determine the stride to equal 3. If the first substring of the message matches with the search string of the entry 501, the CAM logic 258 may use the values in the output portion of the entry 501 to detect a next set of entries. The CAM logic 258 may use the next set of entries to detect the presence of a subsequent substring.

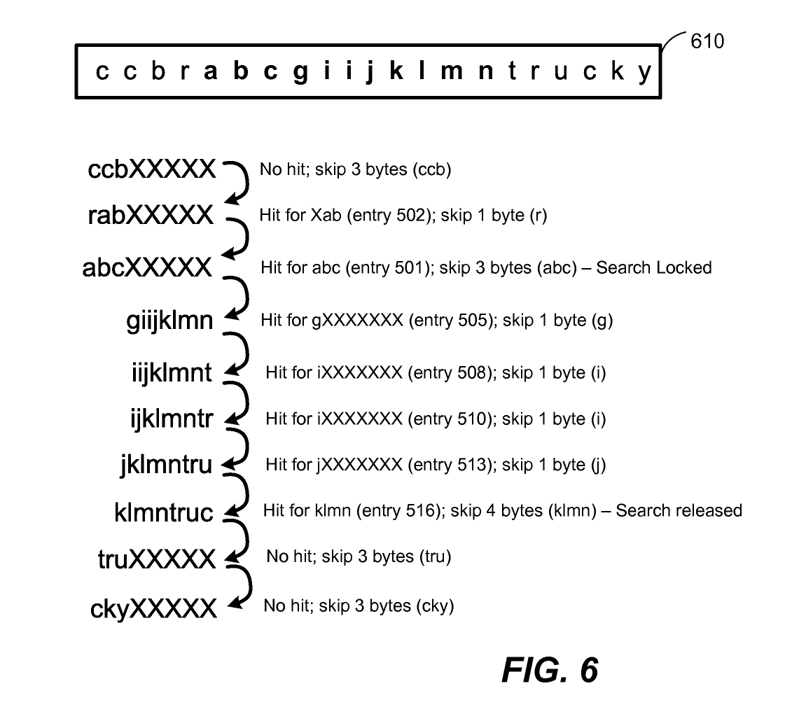

An embodiment of the CAM 250 detecting the presence of a string corresponding to the regular expression 405 is depicted in FIG. 6. For example, the CAM 250 may receive a message 610 equaling ‘ccbrabcgiijklmntrucky’ and the message 610 may comprise a string ‘abcgiijklmn’ that may correspond to the regular expression 405. The CAM logic 258 may compare a first substring equaling ‘ccb’ with the entries 501-516 and may determine that there is no hit for ‘ccb’ as none of the entries comprise ‘ccb’. The CAM logic 258 may choose a length of the substring for comparison based on the stride value. The CAM logic 258 may then skip the number of bytes indicated by the stride value.

The CAM logic 258 may compare a second substring ‘rab’ with the entries 501-516 stored in the memory 252 and may determine a match in the entry 502 as the SS field of the entry 502 equal ‘XabXXXXX’. The output portion of the entry 502 comprises 0, 000, and 1 as the FS, the NS, and the BS field values respectively. A ‘0’ in the FS field indicates that the string ‘abcgiijklmn’ is not completely matched. A ‘000’ in the NS field indicates that matching may be continued by comparing the subsequent substring with the SS field of entries having corresponding IS equaling 000. A ‘1’ in the BS field indicates that one byte ‘r’ in the second substring may be skipped for a subsequent comparison.

The CAM logic 258 may determine that the IS field of entries 501, 502, and 503 equal ‘000’. However, the CAM logic 258 may determine a match in the entry 501 as that the SS field of the entry 501 comprises a string ‘abc’ and the CAM logic 258 may ‘lock’ the search operation. In one embodiment, the CAM logic 258 may change the stride value, for example, to equal the width of a memory location in the memory 252 after ‘locking’ the search operation. For example, the width of the memory location may equal 8 bytes and the CAM logic 258 may change the stride value to equal 8. However, the CAM logic 258 may set the stride value back to the original value (3 in the above example) after the search operation is ‘released’. Such an approach may increase the speed of comparison during the ‘lock’ phase of the search operation.

The CAM logic 258 may, based on the NS field of the entry 501 equaling 001, identify the next set of entries for a subsequent comparison. For example, the CAM logic 258 may determine that the entries 504 and 505 may be used for the subsequent comparison as the IS of the entries 504 and 505 equals 001. The BS field of the entry 501 equals 3, accordingly, the CAM logic 258 skips 3 bytes (abc) and selects the next substring, in the message, starting from ‘g’. The CAM logic 258 may determine that the entry 505 matches a subsequent string ‘gXXXXXXX’. The BS field of the entry 505 equals 1, accordingly 1 byte may be skipped and the CAM logic 258 may determine the next set of entries to equal 510, 513, and 516 based on the NS field of the entry 505. The CAM logic 258 may determine that the substring ‘jXXXXXX’ matches the SS field of the entry 508. Similarly, the CAM logic 258 may determine that the substrings ‘I’, ‘j’, and ‘klmn’ match the entries 510 (‘iXXXXXXX’), 513 (‘jXXXXXXX’), and 516 (‘kImnXXXX’) respectively. The CAM logic 258 may release the search operation after detecting the presence of a string corresponding to the regular expression 405.

In one embodiment, the CAM logic 258 may determine the presence of the string corresponding to the regular expression 405 based on the FS field of the matching entry (516). In one embodiment, the CAM logic 258 may use the NS field of the entry that matches with a last substring of the string to indicate the identifier of the regular expression. As the FS field of the entry 516 equals 1, the CAM logic 258 may cause an identifier (RE1) representing the first regular expression 405 to be stored in the NS field. The BS field (=4) indicates that 4 bytes, in the message, may be skipped and next 3 bytes (=stride value) may be considered for subsequent searches.

In one embodiment, the CAM logic 258 may detect the presence of an overlapping string corresponding to a regular expression RE2 as well. In one embodiment, the CAM 250 may store entries in the memory 252 based on the tree 430 to detect such one or more overlapping strings. In one embodiment, the nodes 421 and 422 may represent the regular expression RE2. In one embodiment, the CAM logic 258 may add control data to indicate occurrence of one or more overlapping strings and the location at which each of the overlapping strings occur. For example, a message and an overlapping string may respectively equal ‘ccbrabcgiijklmptrucky’ and ‘jklmp’. The CAM logic 258 may determine the presence of the overlapping string ‘jklmp’ and may detect the absence of the string ‘abcgiijklmn’ as well.

In one embodiment, the CAM logic 258 may add an entry 517 and control data such as location identifier (L-ID) to the entries 511-513. The control data may indicate the location of a first byte of the overlapping string ‘jklmp’. In one embodiment, the CAM logic 258 may detect ‘abc’ and lock the search operation to detect the first string ‘abcgiijklmn’ and the CAM logic 258 may store the location (Lᵢ) of the first substring (‘j’ in the above example) of the overlapping sting. The CAM logic 258 may subsequently restart the search for the overlapping string ‘jklmp’ from location Lᵢ, if the first string is not found. In another embodiment, the CAM logic 258 may generate an exception handler and the controller 220 may determine the overlapping string based on the exception handler.

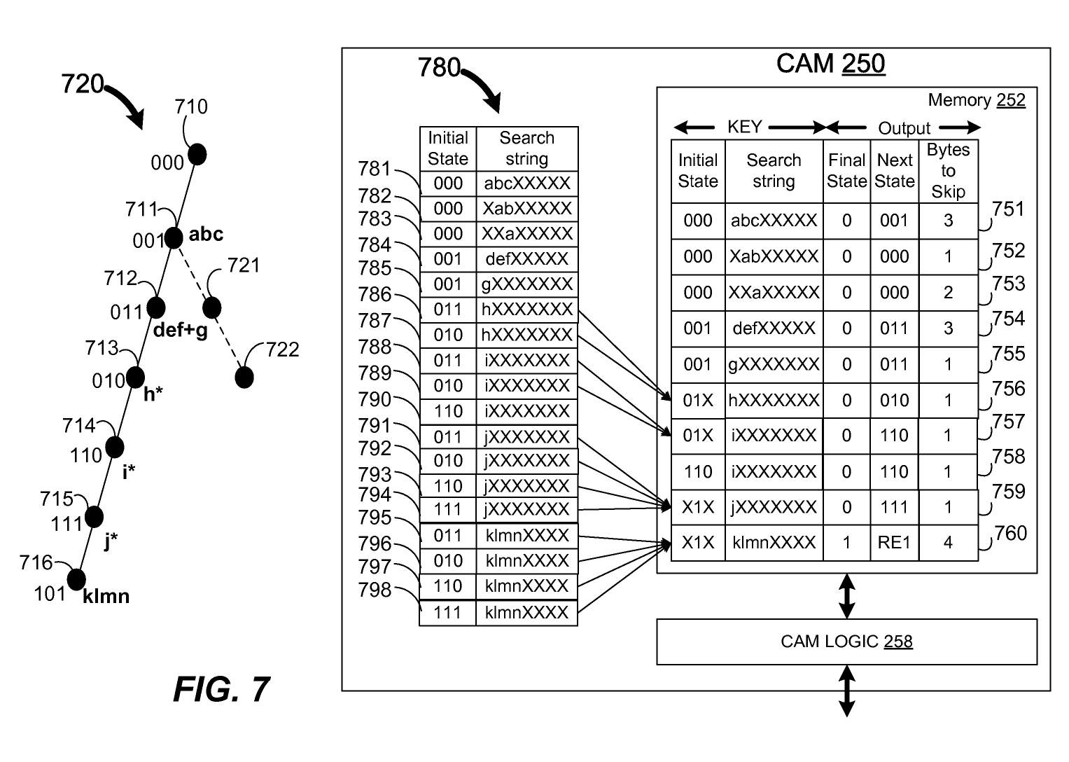

An embodiment of the CAM 250 storing reduced number of entries to detect the presence of strings corresponding to the regular expression 405 is depicted in FIG. 7. The tree 720 may comprise nodes 710-716 and the CAM logic 258 may assign states differing by one bit to each pair of adjacent nodes such as (710,711), (711,712), (712,713), (713,714), (714,715), and (715,716). For example, the CAM logic 258 may assign states (001,011), (011,010), (010,110), (110,111), and (111,101) respectively to the adjacent nodes and the states assigned to adjacent nodes may differ by one bit. As a result, two and/or four adjacent nodes assigned to states that differ by one bit may be merged into one entry and the initial state of the merged entry may, accordingly, comprise one or more ‘don't care’ bits.

The tree 720 depicts the association between the substrings corresponding to the RE1 405. The tree 720 comprises a root node 710. Each node 711-716 of the tree 720 may be associated with a substring (abc), (def+g), (h*), (i*),(j*), and (klmn) of the regular expression 405 respectively. The nodes 711-716 may be assigned states 001, 011, 010,110,111, and 101 respectively.

The CAM 258 may generate 18 entries 781-798, as shown in table 780, based on the tree 720. However, some entries comprising initial states differing by one bit may be merged into one entry to reduce the number of entries. For example, the entries 786 and 787, 788 and 789, 791-794, and 795-798 comprise initial states differing by one bit. Thus, the CAM logic 258 may merge the entries 786 and 787, 788 and 789, 791-794, and 795-798, respectively, into entries 756, 757, 759, and 760. The entries 756 and 757 respectively comprise ‘01X’ as the initial states. The entries 759 and 760 respectively comprise ‘X1X’ as the initial state, wherein X is a ‘don't care’.

As a result of assigning states that differ by one bit to adjacent nodes in the tree 720, the CAM logic 258 may detect the presence of a string corresponding to the regular expression 405 by storing 10 entries in the memory 252. To this end, the memory 252 may store only 10 entries as compared to 16 entries generated based on assigning states that may differ by more than one bit to the adjacent nodes of the tree 430. The CAM logic 258 may detect the presence of a string corresponding to the regular expression 405 in a substantially similar manner as described above with reference to FIG. 5.

In another example, the CAM 250 may receive a message comprising a string ‘abcghhhhhhhhhhjklmncar’ and the CAM logic 258 may perform 14 comparisons C1-C14 to determine that the string ‘abcghhhhhhhhhhjklmn’ is present in the message. The 14 comparisons are C1: abcXXXXX- abc matched entry 751; C2: ghhhhhhh-g matched; entry 756; C3: hhhhhhhh-h matched; entry 757; C4: hhhhhhhh-h matched; entry 757; C5: hhhhhhhh-h matched; entry 757; C6: hhhhhhhh-h matched; entry 757; C7: hhhhhhjk-h matched; entry 757; C8: hhhhhjkl-h matched; entry 757; C9: hhhhjklm-h matched; entry 757; C10: hhhjklmn-h matched; entry 757; C11: hhjklmnc-h matched; entry 757; C12: hjklmnca-h matched; entry 757; C13: jklmncar-j matched; entry 759; C14: klmncart-klmn matched; entry 760.

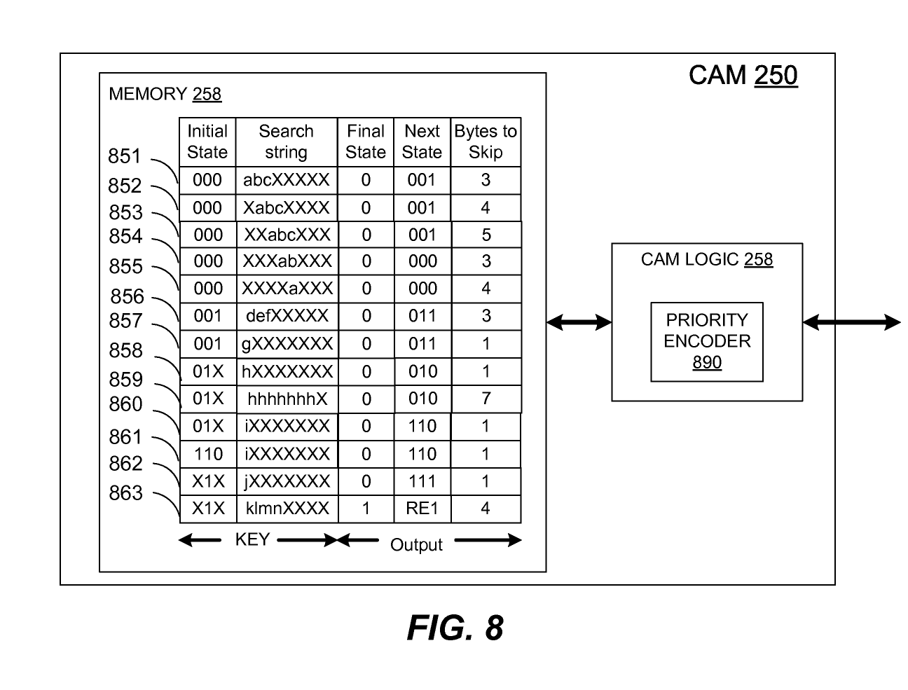

An embodiment of the CAM 250 illustrating optimizations in computational resources and memory size for detecting the presence of a string corresponding to the regular expression 405 is shown in FIG. 8. In one embodiment, a few entries, in addition to the entries 751-760, may be added to the memory 252 to optimize the number of comparisons and the size of the memory 252 as well. The entries 851, 854-858, and 860-863 are, respectively, similar to the entries 751-760. In one embodiment, the CAM logic 258 may add entries 852 and 853 to capture the occurrences of a substring ‘abc’ at different offsets. As a result of adding the entries 852 and 853, the stride value can be increased from 3 to 5. For example, the entries 852 and 853 detect the presence of a substring ‘abc’ respectively at an offset of 1 and 2 bytes.

In another embodiment, if a message comprises one or more substrings that are repeated, the CAM logic 258 may reduce the number of comparisons by adding few additional entries such as an entry 859. For example, if a message comprises ‘abcghhhhhhhhhhjklmncar’, the CAM logic 258 may require 14 comparisons, which comprise ten comparisons (comparison C3 to C12 noted above) for detecting ten occurrences of ‘h’. However, by adding an entry 859 equaling ‘hhhhhhhX’, the number of comparisons to detect ten occurrences of ‘h’ may be reduced to four. Such an additional entry 859 may detect 7 occurrences of “h” in one comparison. The remaining 3 occurrences of ‘h’ may be detected by 3 comparisons based on the entry 858. Thus, the CAM logic 258 may require only 8 comparisons (1 comparison to detect abc, 1 comparison to detect g, 4 comparisons to detect 10 occurrences of h, 1 comparison to detect j, and 1 comparison to detect klmn) to detect the string ‘abcghhhhhhhhhhjklmncar’ as compared to 14 comparisons.

However, the CAM logic 258 may detect multiple hits as two or more entries such as 858 and 859 may match the substring ‘h’ in the message. The CAM logic 258 may comprise a priority encoder 890 to choose, from the matching entries, the entry stored at the highest CAM address. For example, the CAM logic 258 may detect a hit for the substring ‘h’ at entries 858 (‘hXXXXXXX’) and 859 (‘hhhhhhhX’), the entry 859 at the higher CAM address may be chosen and a value of the BS field (=7) may be used to skip the bytes.

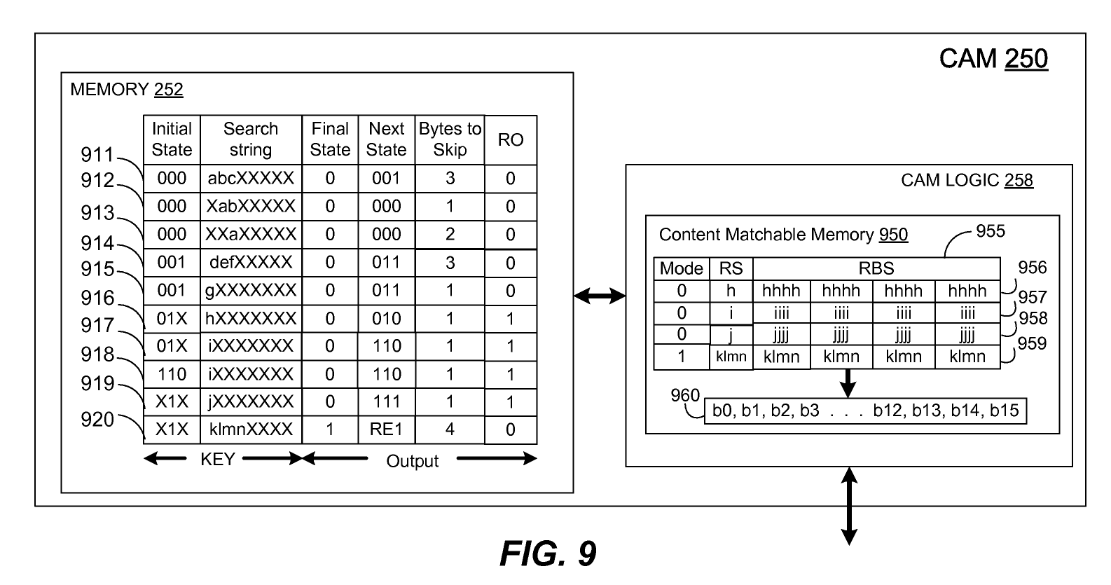

An embodiment of the CAM 250 comprising a content matchable memory (CMM) 950 is depicted in FIG. 9. In one embodiment, the CMM 950 may comprise a match logic 955 and a register 960.

In one embodiment, the match logic 955 may detect the presence of one or more occurrences of a substring in the message quickly in one or more cycles of comparison. The match logic 955 may store, for example, fields such as a mode field, substring key (SK) field, and the recurring bytes of the substring (RBS) field, which may be used for comparison.

In one embodiment, the match logic 955 may operate in one or more modes based on the value stored in the mode field. In one embodiment, the mode field may be set to a logic level such as ‘0’ or ‘1’ to respectively represent, for example, byte mode and the bit mode. However, more bits may be used to operate the match logic 955 in more than two modes. For example, if the mode bit equals 0, the match logic 955 may operate in a byte mode and the size of the SK may equal a byte. The match logic 955 may match each byte in the RBS field with a substring in the message and may set a corresponding bit in the register 960 if the substring matches the byte in the RBS field.

If the mode bit equals 1, the match logic 955 may operate in a bit mode. In one embodiment, the size of the SK may equal 4 bytes (=32 bits). The match logic 955 may match, for example, using ‘klmn’ as the SK and may set a first bit in the register 960 to a logic 1 after detecting the presence of the substring ‘klmn’ in the message. However, the match logic 955 may set more bits of the register 960 to logic 1 if the match logic 955 detects more occurrences of ‘klmn’ in the message. However, while operating in bit mode with SK equaling 32-bits, the match logic 955 may set four bits of the register 960 to logic 1 if the substring ‘klmn’ occurs four times in the message.

In one embodiment, the RE1 405 indicates one or more repeated occurrence of substrings ‘h’, ‘I’ and ‘j’ and the CAM logic 258 may set a repeated occurrence (RO) field of one or more corresponding entries to logic 1. The RO bit, when set, indicates that there may be a corresponding entry present in the CMM 950 and the CAM logic 258 may pass control to the CMM 950. The CMM 950 may continue to match the repeated substrings. For example, if a message comprises a string such as ‘abcghhhhhhhhhhjklmncar’, the CAM logic 258 may determine that entries 911 and 915 may respectively match the substrings ‘abc’ and ‘g’. The CAM logic 258 may then determine that the entry 916 matches the substring ‘h’. The CAM logic 258 may determine that the RO field of the entry 916 equals logic 1 and may pass control to the CMM 950.

The match logic 955 may use the corresponding substring ‘h’ as a search key for detecting more occurrences of the search key in the message. The match logic 955 may detect the occurrences of a substring ‘h’ in the message in one or more cycles based on the number of bytes/bits that may be compared during each comparison. For example, the message ‘abcghhhhhhhhhhjklmncar’ may comprise 10 occurrences of ‘h’, and in one embodiment, the match logic 955 may comprise 16 bytes of ‘h’, as shown in row 956. The match logic 955 may compare 16 bytes of ‘h’ with 10 occurrences of the substring ‘h’, in the message, in one comparison. The match logic 955 may set the bits b0 to b9 of the register 960 to logic 1 to indicate 10 occurrences of the substring ‘h’ and the remaining bits b9-b15 may be set to 0. After the comparison, the register 960 may comprise a value ‘1111 1111 1100 0000’.

However, the number of bytes/bits that may be matched in the match logic 955 may vary. In one embodiment, the match logic 955 may comprise 8 only bytes in the RSB field and may compare 8 occurrences of the substring ‘h’, in the message, during a first comparison. As a result of the first comparison, the register 960 may comprise a value ‘1111 1111’ to indicate presence of 8 occurrences of the substring ‘h’. The match logic 955 may continue the search to detect more occurrences of the substring ‘h’ in a second comparison. As a result of the second comparison, the register 960 may comprise a value 1100 0000 0000 0000, which indicates two more occurrences of the substring ‘h’. Accordingly, the match logic 955 may detect 10 occurrences of the substring ‘h ’ in 2 cycles. The match logic 955 may determine that the repeated occurrences of a substring have all been matched by peeking into the contents of the register 960.

The CAM logic 258 may then continue to match the next substring present in the message. The CAM logic 258 may determine that the next substring equals ‘j ’ and the RO field of a corresponding matching entry 917 is set. The CAM logic 258 may transfer the search operation to the match logic 955 and the match logic 955 may continue to match the substring ‘j’. The match logic 955 may compare the substring ‘j ’ with a byte in the row 958. As a result of the comparison, the register 960 may comprise ‘1000 0000 0000 0000’. The CAM logic 258 may determine a matching entry 920 for a subsequent substring equaling ‘klm’. The CAM logic 258 may determine that the RE1 is found as the FS field equals 1 and the corresponding NS field indicates the identifier of the RE1.

Assuming that the regular expression may comprise a substring (klmn*), the match logic 955 may store, as shown in a row 959, a group of bytes ‘klmn’ as the SK. However, based on the occurrence of the substring ‘klmn’ in the message, the match logic 955 may set or reset only 4 bits b0 to b3 in the register 960. Each bit set may represent a match of 4 bytes such as ‘klmn’ of the RSB field with the substring ‘klmn’ of the message. As a result, 4 occurrences of the substring ‘klmn’ may be detected in one comparison. The above approach may be extended to, for example, a mode field comprising 2 bits to support 4 different lengths of SK.

Certain features of the invention have been described with reference to example embodiments. However, the description is not intended to be construed in a limiting sense. Various modifications of the example embodiments, as well as other embodiments of the invention, which are apparent to persons skilled in the art to which the invention pertains are deemed to lie within the spirit and scope of the invention.

What is claimed is:

1. An apparatus to process network messages comprising
a memory to store a plurality of entries, and
a content addressable memory logic to determine the presence of a plurality of strings corresponding to a first regular expression in the one or more messages, wherein the first regular expression represents a set of strings.

2. The apparatus of claim 1, wherein the content addressable memory logic constructs a tree representing one or more regular expressions by assigning a state to nodes of the tree and to generate the plurality of entries based on the state assigned to the nodes of the tree, wherein the state represents a combination of binary digits.

3. The apparatus of claim 2, wherein the content addressable memory logic generates each entry, of the plurality of entries, to comprise a key portion and an output portion, wherein the key portion is used to match a plurality of substrings of the one or more messages and the output portion is used to traverse the subsequent nodes of the tree.

4. The apparatus of claim 3, wherein the content addressable memory logic
compares a first substring of a first message with a search string field of the output portion of a first entry,
compares a second substring of the first message with search string fields of a set of second entries if the first substring matches with the search string field of the first entry, the set of second entries is identified based on a next state field of the output portion of the first entry and an initial state field of the set of second entries,
determines a matching entry as one of the set of second entries, wherein the search string field of the matching entry matches with the second substring and the second string is determined based on a bytes to skip field of the output portion of the first entry, and
continues to compare until the final state field of an entry indicates that a first string corresponding to the first regular expression is present in the first message or until the comparison yields a mismatch.

5. The apparatus of claim 2, wherein the content addressable memory logic determines the presence of one or more overlapping strings in the first message, wherein the output portion comprises a location identifier field to store the starting location of the overlapping string.

6. The apparatus of claim 1 the content addressable memory further comprises
a memory to store a plurality of entries, and
a content addressable memory logic to construct a tree representing one or more regular expressions by assigning a state, differing by one bit, to each node of the tree, to generate the plurality of entries based on the tree, and to compare the message with the plurality of entries.

7. The apparatus of claim 6, wherein the content addressable memory logic generates each entry, of the plurality of entries, comprising a key portion and an output portion, the key portion comprises an initial state field and a search string field and the output portion comprises a final state field, next state field, and bytes to skip field.

8. The apparatus of claim 6, wherein the content addressable memory logic causes to store at least one merged entry to represent two or more entries having corresponding initial state fields differing by one bit and the corresponding search string fields being equal, wherein an initial state field of the merged entry comprises one or more don't care bits.

9. The apparatus of claim 7, wherein the content addressable memory logic compares a first substring of a first message with the search string field of a first entry,
compares a second substring of the first message with the search string field of a set of second entries if the first substring matches with the search string field of the first entry, the set of second entries is identified based on the next state field of the first entry and the initial state field of each of the set of second entries,
determines a matching entry as one of the set of second entries, wherein the search string field of the matching entry matches with the second substring and the second string is determined based on the bytes to skip field of the first entry, and
continues to compare until the final state field of an entry indicates that a first string corresponding to the first regular expression is present in the first message or until the comparison yields a mismatch.

10. The apparatus of claim 6, wherein the content addressable memory logic adds at least one additional entry comprising at least one repeated occurrence of a substring present in the first regular expression.

11. The apparatus of claim 10 the content addressable memory logic further comprises a priority encoder to select an entry, from a set of matching entries, comprising maximum occurrences of a first substring.

12. The apparatus of claim 6, wherein the content addressable memory logic generates the plurality of entries with each entry comprising a key portion and an output portion, the key portion comprises an initial state field and a search string field and the output portion comprises a final state field, next state field, bytes to skip field, and a repeated occurrence field.

13. The apparatus of claim 12, wherein the content addressable memory logic sets the repeated occurrence field of one or more of the plurality of entries that comprise a recurring substring to a pre-specified value.

14. The apparatus of claim 12 wherein the content addressable memory logic transfers control to a content matchable memory if the repeated occurrence field of a matching entry equals a pre-determined value.

15. The apparatus of claim 12 wherein the content matchable memory further comprises
a register to store a plurality of bits, wherein each bit stores a first logic level or a second logic level based on a compare signal, and
a match logic to generate the compare signal to set first M bits of the register to a first logic level on detecting M occurrences of the recurring substring in the first message.

16. A method of processing network data in a network device, comprising determining the presence of one or more strings corresponding to a first regular expression in one or more messages, wherein the first regular expression represents a set of strings.

17. The method of claim 16 further comprises
constructing a tree representing one or more regular expressions by assigning a state to each node of the tree,
generating a plurality of entries based on the state assigned to each node of the tree, wherein each state represents a combination of binary digits, and
storing the plurality of entries.

18. The method of claim 17 further comprises generating each entry, of the plurality of entries, to comprise a key portion and an output portion, wherein the key portion is used to match a plurality of substrings of the one or more messages and the output portion is used to traverse the subsequent nodes of the tree.

19. The method of claim 18 comprises
comparing a first substring of a first message with a search string field of the output portion of a first entry,
comparing a second substring of the first message with search string fields of a set of second entries if the first substring matches with the search string field of the first entry, the set of second entries is identified based on a next state field of the output portion of the first entry and an initial state field of the set of second entries,
determining a matching entry as one of the set of second entries, wherein the search string field of the matching entry matches with the second substring and the second string is determined based on a bytes to skip field of the output portion of the first entry, and
continuing to compare until the final state field of an entry indicates that a first string corresponding to the first regular expression is present in the first message or until the comparison yields a mismatch.

20. The method of claim 16 comprises determining the presence of one or more overlapping strings in the first message, wherein the output portion comprises a location identifier field to store the starting location of the overlapping string.

21. The method of claim 16 further comprises
constructing a tree representing one or more regular expressions by assigning a state, differing by one bit, to each node of the tree,
generating a plurality of entries based on the tree, and to compare the message with the plurality of entries,
storing the plurality of entries.

22. The method of claim 21 comprise generates each entry, of the plurality of entries, comprising a key portion and an output portion, the key portion comprises an initial state field and a search string field and the output portion comprises a final state field, next state field, and bytes to skip field.

23. The method of claim 21 comprises storing at least one merged entry to represent two or more entries having corresponding initial state fields differing by one bit and the corresponding search string fields being equal, wherein an initial state field of the merged entry comprises one or more don't care bits.

24. The memory of claim 22 comprises
comparing a first substring of a first message with the search string field of a first entry,
comparing a second substring of the first message with the search string field of a set of second entries if the first substring matches with the search string field of the first entry, the set of second entries is identified based on the next state field of the first entry and the initial state field of each of the set of second entries,
determining a matching entry as one of the set of second entries, wherein the search string field of the matching entry matches with the second substring and the second string is determined based on the bytes to skip field of the first entry, and
comparing until the final state field of an entry indicates that a first string corresponding to the first regular expression is present in the first message or until the comparison yields a mismatch.

25. The method of claim 21 comprises adding at least one additional entry comprising at least one repeated occurrence of a substring present in the first regular expression.

26. The method of claim 25 further comprises selecting an entry, from a set of matching entries, comprising maximum occurrences of a first substring.

27. The method of claim 21 comprises generating the plurality of entries with each entry comprising a key portion and an output portion, the key portion comprises an initial state field and a search string field and the output portion comprises a final state field, next state field, bytes to skip field, and a repeated occurrence field.

28. The method of claim 27 comprises setting the repeated occurrence field of one or more of the plurality of entries that comprise a recurring substring to a pre-specified value.

29. The memory of claim 27 further comprises transferring control to a content matchable memory if the repeated occurrence field of a matching entry equals a pre-determined value.

30. The method of claim 27 further comprising
storing a plurality of bits, wherein each bit stores a first logic level or a second logic level based on a compare signal, and
generating the compare signal to set first M bits of the register to a first logic level on detecting M occurrences of the recurring substring in the first message.

31. A network device to process network messages comprising
a network interface to transfer one or more messages, and
a content addressable memory to determine the presence of one or more strings corresponding to a first regular expression in the one or more messages, wherein the first regular expression represents a set of strings.

32. The network device of claim 31 further comprises
a memory to store a plurality of entries, and
a content addressable memory logic to construct a tree representing one or more regular expressions, to generate the plurality of entries, and to detect the presence of one or more strings representing the first regular expression.

33. The network device of claim 31, wherein the content addressable memory detects one or more overlapping strings in a message, wherein the overlapping strings may represent a second regular expression.

34. The network device of claim 31, wherein the one or more messages are received form a text editing application executed on a client system.

35. The network device of claim 32, wherein the one or more messages are received from a security application executed on the network device.
